(19) United States
(12) Patent Application Publication
(10) Pub. No.: US 2025/0053879 A1
(43) Pub. Date: Feb. 13, 2025

(54) Method and System to Enable User Feedback and Summarize Return of Investment for ML Systems

(71) Applicant: ABB Schweiz AG, Baden (CH)

(72) Inventors: Dawid Ziobro, Västerås (SE); Benjamin Kloepper, Mannheim (DE); Marcel Dix, Allensbach (DE); Benedikt Schmidt, Heidelberg (DE); Arzam Muzaffar Kotriwala, Ladenburg (DE); Yemao Man, Solna (SE); Divyasheel Sharma, Bangalore (IN); Gayathri Gopalakrishnan, Eskilstuna (SE); Joakim Astrom, Solna (SE)

(73) Assignee: ABB Schweiz AG, Baden (CH)

(21) Appl. No.: 18/928,369

(22) Filed: Oct. 28, 2024

Related U.S. Application Data
(63) Continuation of application No. PCT/EP2022/061584, filed on Apr. 29, 2022.

(51) Int. Cl. G06N 20/00

(52) U.S. Cl. CPC G06N 20/00

(57) ABSTRACT

A method for enabling user feedback and summarizing return of investment for machine learning systems includes providing a training data set and an initial machine learning model; providing a result of the initial machine learning model; receiving feedback on the result of the initial machine learning model from a user enriching the training dataset based on the feedback to an enriched data set; and retraining the initial machine learning model to a retrained machine learning model based on an enriched data set.

### CROSS-REFERENCE TO RELATED APPLICATIONS

The instant application claims priority to International Patent Application No. PCT/EP2022/061584, filed Apr. 29, 2022, which is incorporated herein in its entirety by reference.

### FIELD OF THE DISCLOSURE

The present disclosure generally relates to a method and a system to enable user feedback and summarize return of investment for machine learning systems.

### BACKGROUND OF THE INVENTION

The general background of this disclosure is interactive machine learning, ML, in the form of for instance active learning, explanatory learning, or visual interactive labeling are a good way to acquire labels for supervised machine learning models.

Artificial intelligence models are increasing in popularity and are becoming more frequently used in industrial application. To archive desired machine learning model performance the models should be continuously updated to maintain desired performance across a longer time span.

The continuous updated are necessary due to the dynamic conditions of industrial environments and machines which are continuously modified to meet customer requirements and business goals.

As the conditions change the capabilities and performance of the models can degrade. To avoid the degradation of model performance there is a need to provide intuitive tools and streamlined process (and interfaces) that allow end users to easily provide input to AI models.

In the process of providing and assimilating input for AI models following challenges could arise and should be resolved: a lack of suitable interactive explanations allowing user to provide compatible feedback, a lack of understanding which mechanism were used during feedback process and how it impacted the upgraded AI model, an incompatible input type or format for a specific AI model which makes assimilation and upgrade troublesome a lack of tools that allow user to state an aspect of interest regarding the reasoning of an ML model.

### BRIEF SUMMARY OF THE INVENTION

In one aspect, the present disclosure describes a method for enabling user feedback and summarizing return of investment for machine learning systems is provided, the method comprising: providing a training data set and an initial machine learning model; providing a result of the initial machine learning model; receiving feedback on the result of the initial machine learning model from a user enriching the training dataset based on the feedback to an enriched data set; retraining the initial machine learning model to a retrained machine learning model based on an enriched data set.

### BRIEF DESCRIPTION OF THE SEVERAL VIEWS OF THE DRAWING(S)

FIG. 1 illustrates a system that enables a user to provide feedback and see the return of investment of the provided feedback in a feedback session summary view.

FIG. 2 is a force plot that has interactive intersections representing the features contributing to a prediction. Slider component has been integrated in the plot allowing user to change the positions of the intersections and thereby deciding how much each feature should contribute to a local or global prediction.

FIG. 3 illustrates an example of how decision boundaries for ML model are displayed and interactive line component is used to allow the user to provide input about the decision boundaries, thus stating which predictions may have been incorrectly predicted.

### DETAILED DESCRIPTION OF THE INVENTION

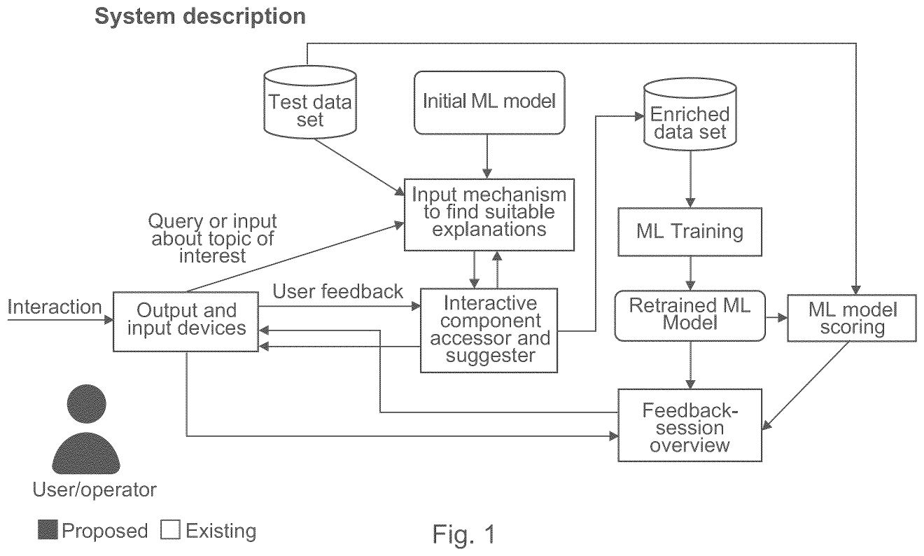

FIG. 1 illustrates the system that enables a user to provide feedback and see the return of investment of the provided feedback in a feedback session summary view. During ML model execution there could be a situation where the end user detects undesired system behaviors that make them wonder about the machine learning (ML) model performance and reasoning. At this stage the user may not understand which aspects contribute to the undesired outcomes that could for example be increasing number of alarms in a Distributed Controls System or relatively high amount of stroke predictions in a medical system. To explore the unexpected system behavior the user may decide to investigate the behavior and reasoning of the ML model that in the technical system of use.

To allow the user to understand which aspects of a ML model that may contribute to desired or undesired behavior we suggest solution that allow user to provide a query that they consider to be of interest. This input is provided to the analyzer that determines which aspects may be interesting to explain or represent to answer the query. The feedback is used to find the most appropriate explanation that are also equipped with interactive components that allow user to provide feedback regarding the explanation.

The feedback is used to retrain a ML model where the user can get an overview of the different mechanism used during the feedback session.

The solutions disclose an input mechanism that allows the user to provide input in multiple ways about aspects of interest regarding a ML model. The input mechanism is device and interaction modality independent meaning that any interaction technique and input modality can be utilized to acquired input form the user.

For example, a text input filed can be displayed in the Human-Machine-Interface that allows the user to type in a query for example “Which features contribute to the prediction the most?”, or using vocal input, stating “Which pixels does the ML discard when predicting a guitar on image 4?” or “what is the accuracy of the last 3 predictions”.

Technologies like Natural language processing, or Flexible Search for syntax identification, can be used to process and analyze the provided input to identify key words or sentences that can be used to find the most suitable explanation classes/types for answering the users' query. The analyzed input is matched towards a “Explainer classification database” that contains information about a ML model's attributes and what types/classes of explanations that can be derived based on those attributes.

The term ML model attributes is meant to include, for example, algorithm(s) (linear regression, KNN, Random Forest, Neural networks) used to train the model, the data format (image, tabular, times series, binary, text, etc.) used during ML model training and applicable explanation methods (SHAP, LIME) compatible with the ML model. The different explanation classes that the “Explainer classification database” contains are for example, features, counterfactuals, confidence score, performance etc.

Should there not be any relevant match between the users input and the “Explainer classification database” then the database returns a low match score, where user is informed via any modal communication channel that the stated query cannot be answered or represented.

The search for suitable explanations can also be triggered by the system that tracks and has triggering thresholds for different criteria, for example: ML model accuracy targets or number of executed tasks for a duration. The analyzer uses this input to calculate and match areas or aspects of interest that should be represented for the user to identifying the reasons for the behavior.

At the stage an exploration is produced but it might not have any interactive components that prohibit the user in providing feedback, and that is where the “Interactive component accessor and suggester” comes in.

The ability for the user to properly provide feedback regarding the explanation comes from the “Interaction technique accessor”. The “Interactive technique accessor” comprises following parts to be able to assess and suggest right type or interactive component that is integrated with the explanation:
(i) Compatible data types (that can be used for ML model training);
(ii) Device type;
(iii) Interaction component database and
(iv) Interaction technique rules.
(i) Since the feedback provided by user should be compatible with data type used for training a ML model the data format needs to be stored and specified. The data format here could be for example, binary, image (even pixel coordinates, color, and amount), tabular, or time series data.
(ii) Device type describes a device and the interactive capabilities it has. As various devices have different interactive capabilities that can be used to provide output or retrieve input the considered to make the best chose in choosing the interactive component that is compatible the input and output capabilities of a device. For example, a Tablet usually has a screen and audio capabilities that can be used to provide output that can be perceived by the user, but rarely gustation (smell) modalities. It is also important to track the interaction capabilities to provide input to a device in the example of a Tablet it would be touchscreen, voice via microphone, touch pen or other.
(iii) Interactive competent database includes any interactive elements that can be used in building up a Human-Machine-Interface. Examples of interactive comments are slider, buttons, text input filed, drop down menu etc. The interactive components have defined interactive behavior(s) and states, like for example buttons, which can have states of press, hold, and release that make them interactively different form other components. The interactive components can also be interacted by using various interactive techniques, for example a button can be interacted with by being pressing on a touchscreen, or by clicking on a mouse when the curser hoover on top of the button.
(iv) Interaction technique rules define what type of interactive component that should be applied to allow the user to provide the appropriate feedback by interacting with the presented explanation. The rules are the glue and intelligence that consider the encompassed parts in the “Interactive component accessor and suggester” and integrate the interactive component, in otherwise static explanations.

The technique rules assess the interactive characteristics or the interactive components, together with the explanation type (plot or type of diagram, or more), device type and incorporates a suitable interactive component into the explanation type allowing it to be interactive.

The interactivity allows to provide feedback about the query of interest. The logic of the interaction technique rules can be exemplified in words accordingly: “If Tablet has touch capabilities and force plot is used as explanation visualization then use slider component to allow position changes of intersections for the represented feature(s)”. As the slider component has already predefined interactive behaviors to not slide outside of its boundaries this allows the user to provide feedback within the given interactive boundaries about how much any features should contribute a prediction, as this was the area of interest states by the user.

Another rule example would be “If 2-dimensional plot is displayed on computer display and decision boundaries is area of interest then choose interactive lines to allow position modification of the decision boundaries through mouse cursor input, if mouse is available.” The rules can be stored in decision trees or other format that is more efficiently read by the system.

The described mechanism produces an interactive explanation that is displayed though any output capability on the used device. At this moment the user can interact with the explained statement and provide feedback.

The provided feedback from the user via the interactive explanation is further used to retrain the ML model in the aim to improve its performance. In the process of providing a query and providing feedback through the interactive explanation the user and system performs various tasks that are can be considers as effort.

Effort is composed of (i) user effort and (ii) system effort performed during the generation of the explanation, and process in providing feedback.
(i) User effort comprises for example the number of interactions performed by the user and duration used to conduct the interaction. Examples or interactions are number of mouse clicks, number of touch inputs, drag interactions, number of keyboard presses, or time spent in when providing vocal input. The system stores the number of interactions in a database that can later be used to calculate the return of investment. Duration of an interaction is for example time between press and release of a 2 consecutive mouse clicks or press and release on any type of touch input.
(ii) System effort comprises for example the amount of computational resources used in the process of retrieving user input, analyzing the input, generating the explanation and other process involved from the beginning of when query is provided by the user until the model is retrained and return of investment is calculated. The start of the process is when the user performs the first interaction that provide input to the input mechanism and ends when the “Return of investment” index (score) has been calculated. This includes the resources also used during process of for example deriving new data sets used to retrain the ML model and the retrain as well, which sometime can be long and resource consuming.

The effort is standardized towards arithmetical values and summarized to get a score about the effort. The various values for example percentage, and duration used during the process are standardized so it becomes possible to calculate a score. The percentage can be transformed to arithmetical value for example 67% transformed to 0.67 while the duration can be translated to points meaning that each millisecond corresponds to 0.01 which is added up as the duration increases. To also allow the system or user to balance how much each measured aspect contributes to the efforts weights are applied to each measured value that can be manipulated and adjusted by the user or provide equal weights if initially unmodified.

Example of a hypothetical formula expressed in words:

$$Effort = Sum ( weight A * aspect value A + weight B * aspect value B + … weight N * aspect value N )$$

Expressed in number example: Effort=Sum (0.2*0.67+0.9*23+0.3*48+ . . . )

The upgraded ML model uses enriched setpoints for retraining which may have impacted the performance in a positive or negative way. To calculate the impact of the feedback on the retrained ML model an overall performance score is calculated upon various values. Examples of the values are F1 score, Precision, Accuracy, AUC and more. The values are summarized to gain an overall performance score for a ML model. Similarly, the overall performance score is calculated for the initial ML model. Then the overall performance score is subtracted from the overall performance score for the initial ML model.

The return of investment score is calculated according to following formula:

Return of investment=((overall performic score for upgraded model)−(overall performance score for initial model))/Effort

By getting the ROI (Return of Investment) calculation user will understanding of how the provided feedback and invested effort impacted the overall performance of the upgraded ML model. The understanding could play a role in how user chooses to provide feedback and how much effort is spent in the goal to improve the performance.

Additionally, the system also stores a history of various datatypes and aspects used in the process of providing the feedback to the ML model. The aim is to create a notion of what and how much was used in the process of providing feedback. The various aspects are represented in a feedback summary view. Examples of data and aspects stored by the system:
(i) images with links of the explanations used,
(ii) Graphical representation of which interactive component were integrated in the explanations. The links take user to the graphical component library.
(iii) Name and graphical representation of the original and retrained model. Interactive link that allows the operator to deploy any of the ML models.
(iv) Return of investment score and values used for calculation.

The system also stores a history of each feedback process where a model was explained and further retrained based on use feedback. By having the overview of different feedback session user can draw conclusion on which exploratory technique and amount of feedback provided the most beneficial or negative impact for various ML models.

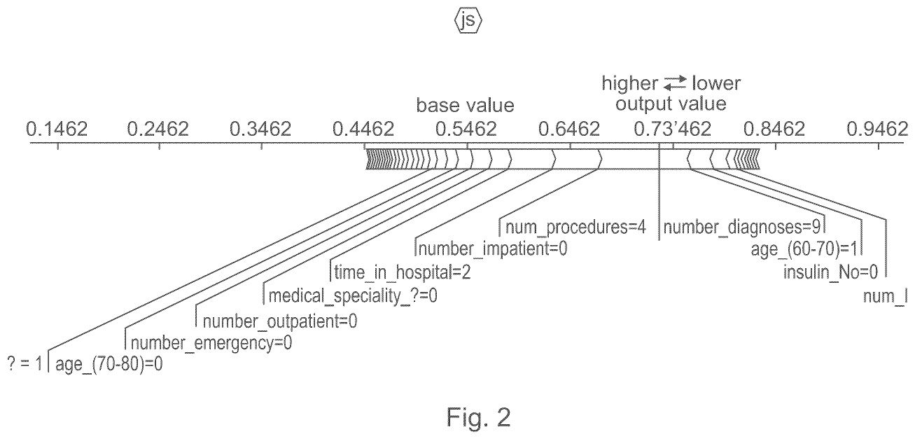

FIG. 2 illustrates Illustration of a force plot that has interactive intersections representing the features contributing to a prediction. Slider component has been integrated in the plot allowing user to change the positions of the intersections and thereby deciding how much each feature should contribute to a local or global prediction.

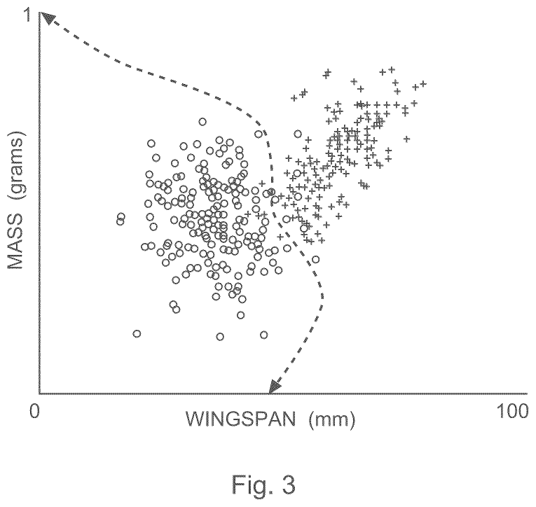

FIG. 3 illustrates an example illustrating how decision boundaries for ML model are displayed and interactive line component is used to allow a user to provide input about the decision boundaries thus stating which predictions may have been incorrectly predicted.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

In an embodiment of the method for enabling user feedback and summarizing return of investment for machine learning systems, the step of receiving feedback on the result of the initial machine learning model from a user is based on queries about an area of interest regarding a reasoning of the initial machine learning model.

In an embodiment of the method for enabling user feedback and summarizing return of investment for machine learning systems, step of receiving feedback on the result of the initial machine learning model from a user is based on interactive explanations allowing a user to provide feedback about the area of interest.

In an embodiment of the method for enabling user feedback and summarizing return of investment for machine learning systems, the step of receiving feedback on the result of the initial machine learning model from a user comprises a feedback summary view.

In an embodiment of the method for enabling user feedback and summarizing return of investment for machine learning systems, the step of receiving feedback on the result of the initial machine learning model from a user comprises a return of investment calculation configured for illustrating a benefit gained regarding the overall initial machine learning model performance.

In an embodiment of the method for enabling user feedback and summarizing return of investment for machine learning systems, the method further comprises the step of integrating interactive components into an explanation that allow user to provide feedback about the area of interest.

In an embodiment of the method for enabling user feedback and summarizing return of investment for machine learning systems, the method further comprises the step of calculating a return of investment for a feedback process based on the retrained machine learning model.

In an embodiment of the method for enabling user feedback and summarizing return of investment for machine learning systems, the method further comprises the step of summarizing mechanisms used during the step of receiving feedback on the result of the initial machine learning model.

In one aspect of the invention a system for enabling user feedback and summarizing return of investment for machine learning systems is provided, the system comprising a processor for executing the method according to the first aspect.

Any disclosure and embodiments described herein relate to the method and the system, lined out above and vice versa. Advantageously, the benefits provided by any of the embodiments and examples equally apply to all other embodiments and examples and vice versa.

As used herein “determining” also includes “initiating or causing to determine,” “generating” also includes “initiating or causing to generate” and “providing” also includes “initiating or causing to determine, generate, select, send or receive”. “Initiating or causing to perform an action” includes any processing signal that triggers a computing device to perform the respective action.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for enabling user feedback and summarizing return of investment for machine learning systems, the method comprising:
providing a training data set and an initial machine learning model;
providing a result of the initial machine learning model;
receiving feedback on the result of the initial machine learning model from a user enriching the training dataset based on the feedback to an enriched data set; and
retraining the initial machine learning model to a retrained machine learning model based on an enriched data set;
wherein the step of receiving feedback on the result of the initial machine learning model from a user is based on queries about an area of interest regarding a reasoning of the initial machine learning model, and wherein the step of receiving feedback on the result of the initial machine learning model from a user is based on interactive explanations allowing a user to provide feedback about the area of interest.

2. The method according to claim 1, wherein the step of receiving feedback on the result of the initial machine learning model from a user comprises a feedback summary view.

3. The method according to claim 1, wherein the step of receiving feedback on the result of the initial machine learning model from a user comprises a return of investment calculation configured for illustrating a benefit gained regarding the overall initial machine learning model performance.

4. The method according to claim 1, further comprising integrating interactive components into an explanation that allow user to provide feedback about the area of interest.

5. The method according to claim 1, further comprising calculating a return of investment for a feedback process based on the retrained machine learning model.

6. The method according to claim 1, further comprising summarizing mechanisms used during the step of receiving feedback on the result of the initial machine learning model.
